(19) United States
(12) Patent Application Publication
(10) Pub. No.: US 2009/0086323 A1
(43) Pub. Date: Apr. 2, 2009

(54) COLOR FILTER AND IMAGE SENSOR

(75) Inventor: Momo NOBUYUKI, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/239,024

(22) Filed: Sep. 26, 2008

(30) Foreign Application Priority Data
Sep. 27, 2007 (JP) 2007-250423

(51) Int. Cl. G02B 5/28

(52) U.S. Cl. 359/578

(57) ABSTRACT

In one aspect of the present invention, a color filter capable of controlling wavelengths of light to be transmitted therethrough may include a pair of interferometric films which are substantially parallel to each other and which transmit the light; and a drive member which drives at least one film of the pair of the interferometric films to change a distance of a gap between the interferometric films.

### CROSS REFERENCE TO RELATED APPLICATION

This application is based upon and claims the benefit of priority from Japanese Patent Application No. 2007-250423, filed on Sep. 27, 2007, the entire contents of which are incorporated herein by reference.

### BACKGROUND

A general color image sensor has a structure in which every single pixel has a color filter disposed thereon that allows the pixel to detect only one color, that is, only a wavelength range corresponding to one color in operation of the color image sensor. Specifically, in each of many color image sensors, RGB (red, green and blue) color filters are regularly arrayed so that one color filter corresponds to each pixel. Each pixel with a red color filter detects red light, and green light and blue light are also detected in similar manners.

Thus, in reproducing an image, the color image sensor reproduces green and blue signal in each pixel with a red color filter by calculating intensities of the green and blue colors through signal processing based on information on the adjacent pixel with a green color filter and on the adjacent pixel with a blue color filter. At the same time, red and blue signal in each green pixel, and red and green signal in each blue pixel are also reproduced by using signal processing in similar manners.

As described above, a conventional color image sensor processes an image by allotting one color to each pixel. As a result, the color image sensor has poor reproducibility characteristics for an object showing a significant spatial color variation or an object containing similar colors. For example, from such an object, the color image sensor is likely to reproduce a more unclear image as to look out of focus than the original object. In addition, the conventional technique has a problem that, in a color image sensor having a large number of pixels, each pixel inevitably has such a small structure that its element for detecting light, such as a photodiode, cannot receive a light beam with a sufficient intensity for its detecting operation.

Note that an imaging device with a multilayer interferometric filter has already been known (refer to Japanese Patent Application Publication No. 2005-308871). Meanwhile, a technique of employing interferometric films in a reflective color display device has been also known (refer to Japanese Patent Application Publications No. 2005-77718 and No. 2006-20778).

### SUMMARY

Aspects of the invention relate to an improved color filter and color image sensor.

In one aspect of the present invention, a color filter capable of controlling wavelengths of light to be transmitted therethrough may include a pair of interferometric films which are substantially parallel to each other and which transmit the light;

and a drive member which drives at least one film of the pair of the interferometric films to change a distance of a gap between the interferometric films.

In another aspect of the invention, a color image sensor, may include a color filter including at least one pair of interferometric films which are substantially parallel to each other and which transmit light; a plurality of photoelectric converters which are arrayed two-dimensionally to receive the respective light transmitted through the color filter and to output electrical signals; and a drive member which changes the wavelengths of the light transmitted through the corresponding pair of the interferometric films by moving at least one film of the pair of the interferometric films to change a distance of a gap between the interferometric films.

### BRIEF DESCRIPTIONS OF THE DRAWINGS

A more complete appreciation of the invention and many of the attendant advantages thereof will be readily obtained as the same becomes better understood by reference to the following detailed description when considered in connection with the accompanying drawings.

FIG. 1A is a schematic cross-sectional view showing the color image sensor of the first embodiment. FIG. 1B is a schematic plan view of the color image sensor shown in FIG. 1A. FIG. 1C is a schematic cross-sectional view in which cross-sectional views as viewed from the respective directions of the arrow A-A and the arrow B-B of FIG. 1B overlap on each other.

FIGS. 2A to 2F are schematic cross-sectional views showing the manufacturing process of the color image sensor.

FIG. 3A is a schematic cross-sectional view showing the color image sensor of the second embodiment.

FIG. 3B is a schematic plan view of the color image sensor shown in FIG. 3A. FIG. 3C is a schematic plan view showing a part, corresponding to one pixel, of the color image sensor shown in FIG. 3B.

FIG. 4A is a cross-sectional view as viewed from the direction of the arrow IVa-IVa of FIG. 3C. FIG. 4B is a cross-sectional view as viewed from the direction of the arrow IVb-IVb of FIG. 3C.

### DETAILED DESCRIPTION

Various connections between elements are hereinafter described. It is noted that these connections are illustrated in general and, unless specified otherwise, may be direct or indirect and that this specification is not intended to be limiting in this respect.

Embodiments of the present invention will be explained with reference to the drawings as next described, wherein like reference numerals designate identical or corresponding parts throughout the several views.

### First Embodiment

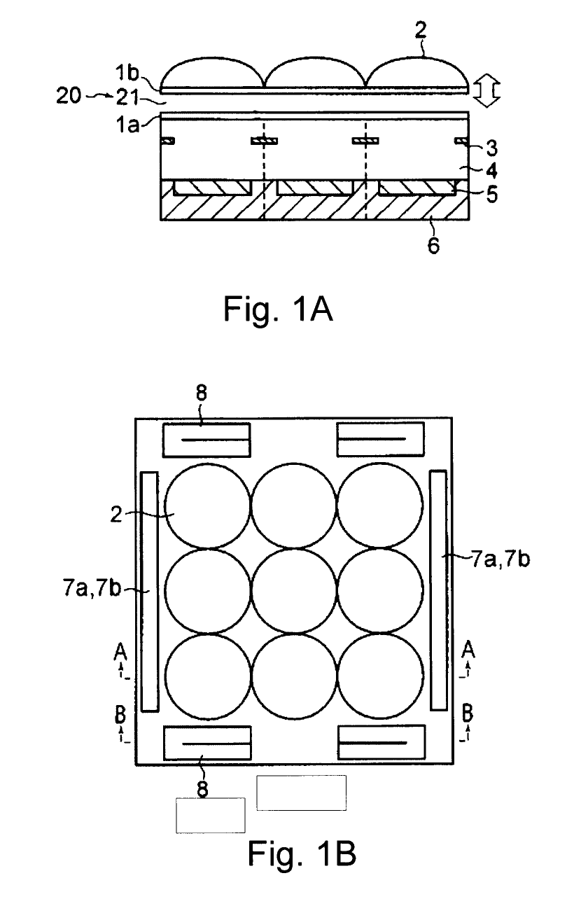

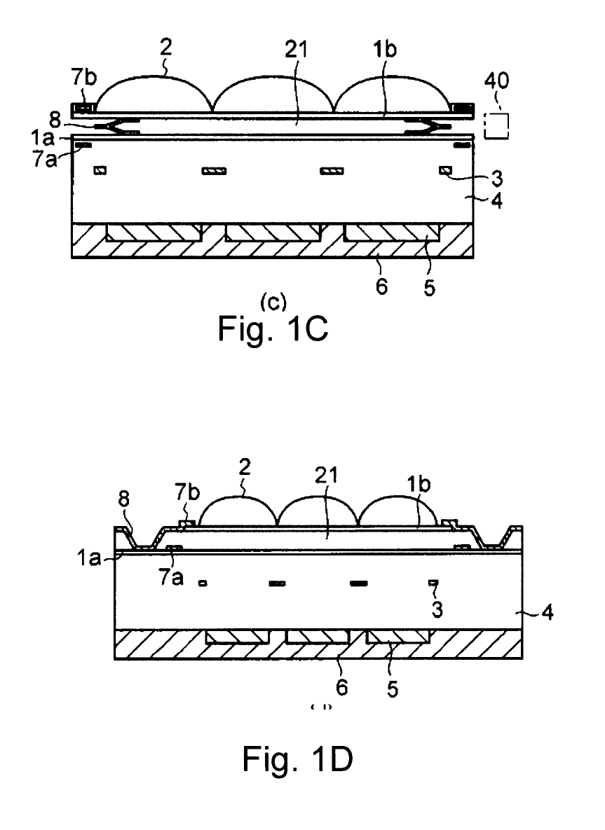

Firstly, with reference to FIGS. 1A to 1C, description will be given of a configuration of a first embodiment of a color image sensor according to the present invention. FIG. 1A is a schematic cross-sectional view showing the color image sensor of the first embodiment. FIG. 1B is a schematic plan view of the color image sensor shown in FIG. 1A. FIG. 1C is a schematic cross-sectional view in which cross-sectional views as viewed from the respective directions of the arrow A-A and the arrow B-B of FIG. 1B overlap on each other.

In the color image sensor, multiple photodiode regions 5, each of which serves as a photoelectric converter corresponding to a pixel, are arranged in horizontal and vertical lines on a substrate 6, and an interlayer insulating film 4 is formed thereon. In the interlayer insulating film 4, an unillustrated wiring layer is formed. A color filter 20 is disposed on the interlayer insulating film 4, and multiple microlenses 2 are arranged at positions corresponding to the respective photodiode regions 5. Though pixels are arranged in 3 horizontal and 3 vertical lines in the example shown in FIGS. 1A to 1C, the number of pixels may typically be far larger than this. For example, several million pixels may be arranged in a matrix in a plane.

In this embodiment, an arrangement is employed in which the single color filter 20 covers the entire matrix of the multiple photodiode regions 5. The color filter 20 has a lower interferometric film 1a directly disposed on the interlayer insulating film 4 and an upper interferometric film 1b disposed parallel to the lower interferometric film (interference film) 1a. Each of the lower and upper interferometric films 1a and 1b is formed of a stable film made, for example, of amorphous silicon. Between the lower and upper interferometric films 1a and 1b, support structures 8 are interposed in a peripheral region outside an optical path, and thus a gap 21 is formed between the lower and upper interferometric films 1a and 1b.

Lower motion control electrodes 7a are attached on the lower surface of the lower interferometric film 1a, and upper motion control electrodes 7b are attached on the upper surface of the upper interferometric film 1b. The lower and upper motion control electrodes 7a and 7b are disposed in the peripheral region outside the optical path so as to face each other in the direction of the optical path. The color image sensor is configured such that a potential difference caused between the lower and upper motion control electrodes 7a and 7b can change the gap distance between the lower and upper interferometric films 1a and 1b. Specifically, if such a potential difference is caused between the two electrodes, an electrostatic force is applied between the two electrodes to deform the support structures 8, and thereby moves the upper interferometric film 1b up and down to change the gap distance. This change in the gap distance between the lower and upper interferometric films 1a and 1b changes the wavelength of interfered light beams. In this way, the wavelength of the light beams transmitted through this color filter is made variable.

As shown in FIGS. 1A and 1C, the light-shielding metal layers 3 are formed in the interlayer insulating film 4 to prevent light beams transmitted through each adjacent microlenses 2 from interfering with one another.

In addition, a distance meter 40 for measuring a distance between the lower and upper interferometric films 1a and 1b is also disposed as shown in FIG. 1C.

In the color image sensor with the above configuration, light beams incident from the respective microlenses 2 are caused to have a certain limited wavelength by the color filter 20 when the light beams is being transmitted therethrough, and then reach the photodiode regions 5. Thereafter, the light beams are photoelectrically converted in the respective photodiode regions 5 to be detected as electrical image data signals.

Then by detecting electrical image data signals as described above after the distance between the lower and upper interferometric films 1a and 1b is changed, the color image sensor can obtain a data set representing a different color. In this way, the color image sensor can obtain data sets representing the respective RGB colors after, for example, three rounds of such data detection. Finally, by overlapping these color data sets, the color image sensor can reproduce a color image.

As described above, the color image sensor produces an image by imaging, that is, detecting colors of, an object with all the pixels one color by one color till all the colors desired to be detected are obtained and then by overlapping these obtained colors by using signal processing. In general, a microelectromechanical system (MEMS) is supposed to have an operation speed on the order of several ten μsec. Accordingly, the color image sensor can be used in high-speed imaging by enhancing performance of peripheral elements such as an analog-to-digital converter (ADC), photodiodes and the like.

Note that this embodiment is applicable to both types of a charge coupled device (CCD) image sensor and a complementary metal oxide semiconductor (CMOS) image sensor.

In the image sensor of this embodiment, the gap distance between the lower and upper interferometric films 1a and 1b can be continuously changed by utilizing a potential difference. This enables the image sensor to reproduce not only the RGB colors but basically all the colors. Accordingly, the image sensor of this embodiment is capable of detecting colors other than the RGB colors, and thus has improved color reproducibility characteristics.

Here, though the gap distance between the lower and upper interferometric films 1a and 1b may be controlled within a predetermined range every time before a certain color is detected, an alternative operation is also possible. In the alternative operation, the color filter 20 is continuously or periodically moved during an imaging session while the distance meter 40 keeps monitoring the height of the color filter 20, and the image sensor reads image signals when the color filter 20 has the height providing the color desired to be obtained. This operational mode eliminates the need to precisely control the movement of the color filter 20, and the precision of the color to be obtained in this operational mode depends on the precision of the height detection instead. Accordingly, employment of this operational mode can simplify the MEMS structure of this image sensor even more.

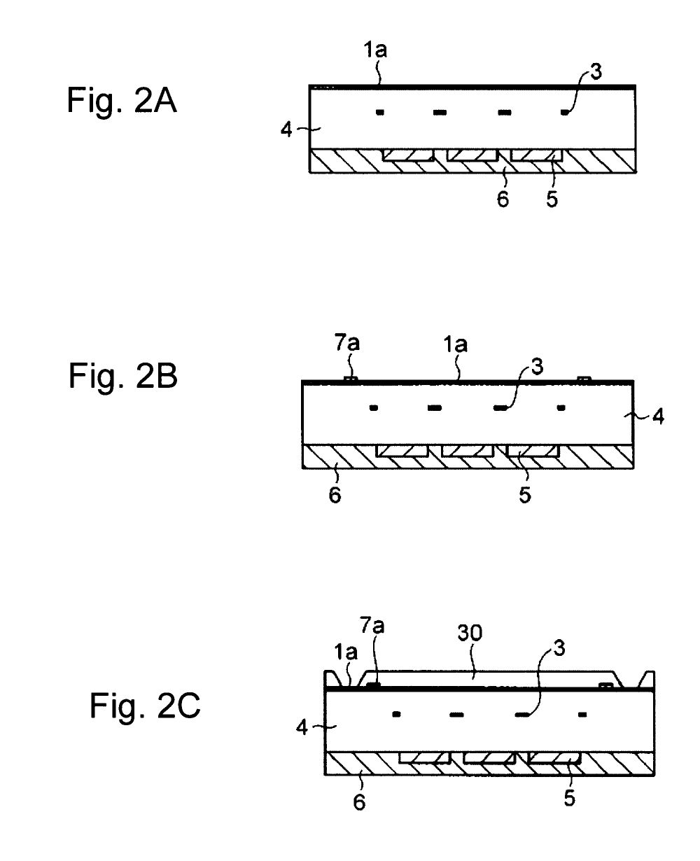

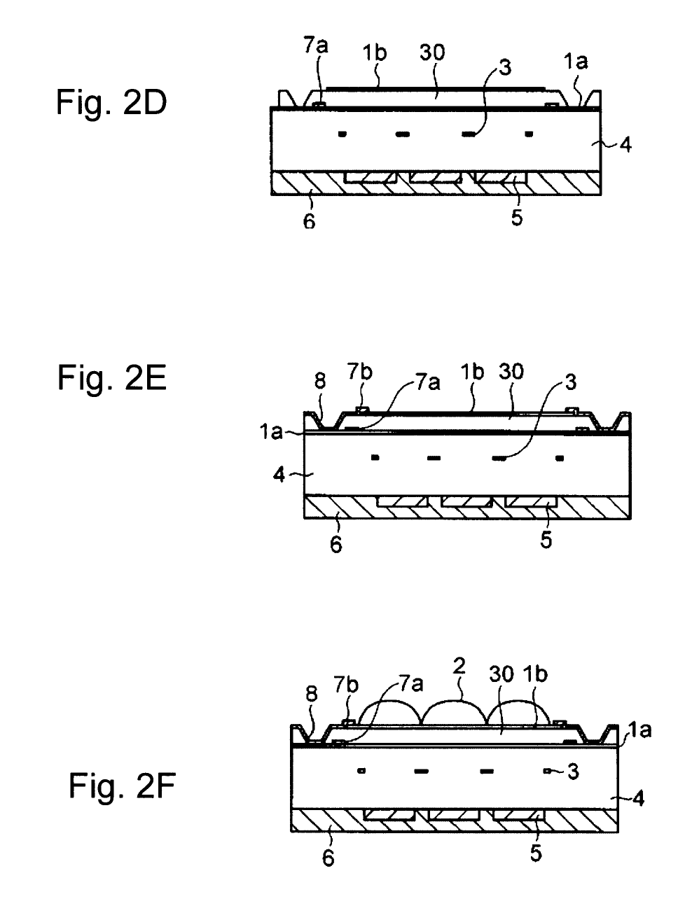

Next, with reference to FIGS. 1D and 2A to 2F, description will be given of a manufacturing process of the color image sensor of this first embodiment. FIG. 1D is a schematic cross-sectional view showing a finished form of the manufacturing process of the color image sensor of this first embodiment. FIGS. 2A to 2F are schematic cross-sectional views showing the manufacturing process of the color image sensor. FIG. 1D is basically the same as FIG. 1C except that the upper motion control electrodes 7b and the support structures 8 in FIG. 1C are integrally formed in FIG. 1D.

Firstly, as shown in FIG. 2A, multiple photodiode regions 5, each of which corresponds to a pixel, are arranged in horizontal and vertical lines on a substrate 6, and then an interlayer insulating film 4 and light-shielding metal layers 3 are formed thereon. Specifically, the light-shielding metal layers 3 are formed in the interlayer insulating film 4. Thereafter, a lower interferometric film la is formed on the interlayer insulating film 4. The steps so far are no different than in conventional techniques. Then, as shown in FIG. 2B, lower motion control electrodes 7a are formed on the lower interferometric film 1a. Then, as shown in FIG. 2C, a sacrificial layer 30 is deposited on the lower interferometric film 1a and the lower motion control electrodes 7a and thereafter patterned.

Then, as shown in FIG. 2D, an upper interferometric film 1b is deposited on the sacrificial layer 30 and thereafter patterned. Subsequently, as shown in FIG. 2E, upper motion control electrodes 7b and a metal layer including support structures 8 are deposited on the upper interferometric film 1b and thereafter patterned. Then, as shown in FIG. 2F, microlenses 2 are formed on the upper interferometric film 1b. Lastly, the sacrificial layer 30 is removed off, and, as a result, the form shown in FIG. 1D is obtained.

Note that as the modification of the above procedure, the upper interferometric film 1b may be formed after the upper motion control electrodes 7b is formed. Still alternatively, the lower motion control electrodes 7a may be formed concurrently with the interlayer insulating film 4 including the wiring layers to position under the lower interferometric film 1a.

According to this first embodiment, each pixel can detect multiple colors at different timings, respectively. This enables the image sensor to obtain fine image data without increasing the number of pixels therein.

Moreover, since the color image sensor of this embodiment has a structure in which the distance between the interferometric films can be continuously changed, each pixel therein is capable of detecting any wavelength. This enables the image sensor to detect not only the RGB colors but also the other colors, and thus to have improved color reproducibility characteristics. Furthermore, the capability of each pixel of detecting all the colors necessary to reproduce an image not only eliminates the need for conventionally-required color correction of the pixel but also allows the color image sensor to obtain an increased number of signals and thus to have improved image reproducibility characteristics. In addition, since the interferometric films, the support structures and the like can be implemented with reliable materials, the reliability of the color image sensor is not decreased unlike the problematic case in which a color image sensor with a conventional color filter formed of an organic film has a seriously decreased reliability.

Moreover, this structure can be implemented using the interferometric films 1a and 1b each formed of a stable film made of a material such as amorphous silicon, and the support structures 8 can be formed of insulating films. Accordingly, an appropriate selection of materials for these films can provide an even higher reliability with the color image sensor.

Especially, the MEMS color filter of this embodiment integrally formed for all the pixels has a simple structure since the motion control electrodes 7a and 7b and the support structures 8 need not be formed in the pixels, and thus can be manufactured by a simple process.

### Second Embodiment

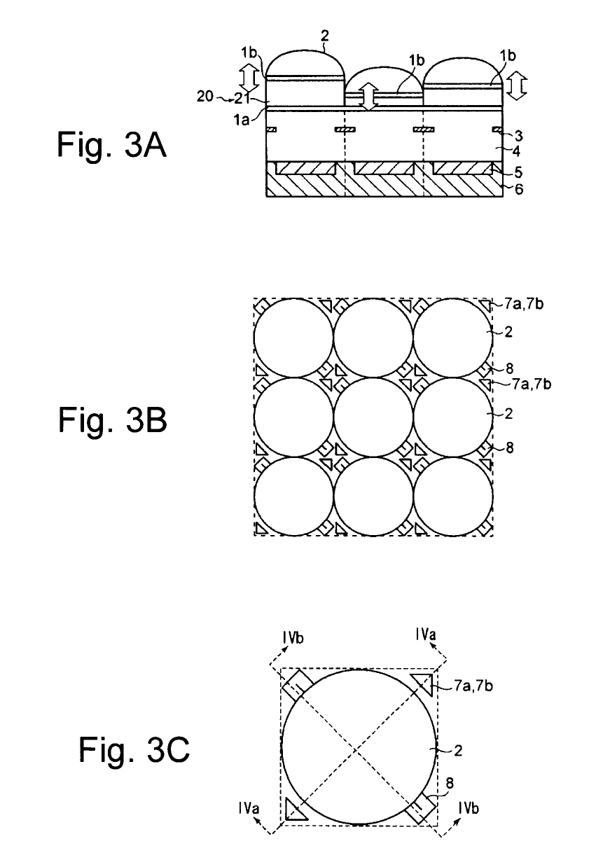

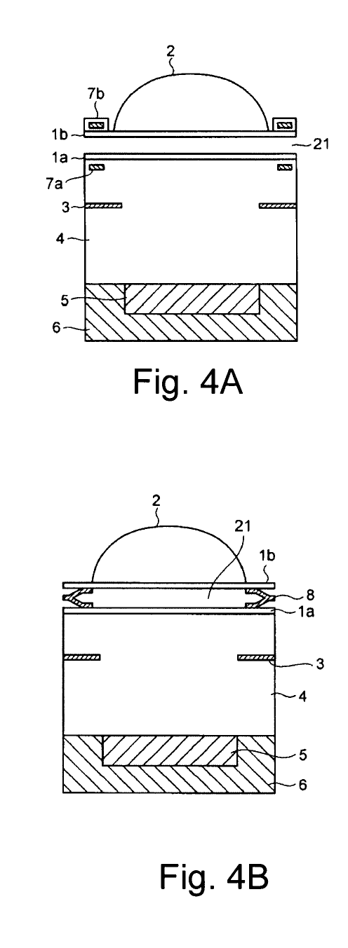

Secondly, with reference to FIGS. 3A to 4B, description will be given of a second embodiment of a color image sensor according to the present invention. Note, however, that the same or similar components as in the first embodiment are denoted by the same reference numerals and the redundant description thereof will be omitted. FIG. 3A is a schematic cross-sectional view showing the color image sensor of the second embodiment. FIG. 3B is a schematic plan view of the color image sensor shown in FIG. 3A. FIG. 3C is a schematic plan view showing a part, corresponding to one pixel, of the color image sensor shown in FIG. 3B. FIG. 4A is a cross-sectional view as viewed from the direction of the arrow IVa-IVa of FIG. 3C. FIG. 4B is a cross-sectional view as viewed from the direction of the arrow IVb-IVb of FIG. 3C.

In this embodiment, the upper interferometric film 1b is separated into portions corresponding to the respective pixels. In addition, the MEMS movement units, that is, the lower motion control electrode 7a, the upper motion control electrodes 7b and the support structures 8, are provided for each pixel so as to individually change the gap distance between the lower and upper interferometric films 1a and 1b in the pixel. Here, in the pixel, the pair of the lower motion control electrodes 7a, the pair of the upper motion control electrodes 7b and the pair of the support structures 8 are each diagonally disposed with respect to the microlens 2, so as not to obstruct a gapless arrangement of the microlenses 2. With this arrangement, the microlenses 2 can be arranged in an array with no gap between one another.

The MEMS color filter of this embodiment is implemented to have a structure allowing an MEMS operation on the one-pixel basis. Thus, if an object image includes a part showing a significant color variation or a part containing similar colors, the color image sensor of this embodiment can detect, from the part, colors critical for image reproduction on the one-pixel basis after detecting basic colors such as the RGB colors from the entire object image. Here, the color image sensor calculates such colors critical for image reproduction by using signal processing. For example, the color image sensor can minutely detect colors around the target wavelengths from the part containing similar colors and can additionally detect colors only in the part showing a significant color variation.

Embodiments of the invention have been described with reference to the examples. However, the invention is not limited thereto.

Other embodiments of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A color filter capable of controlling wavelengths of light to be transmitted therethrough, comprising:
a pair of interferometric films which are substantially parallel to each other and which transmit the light; and
a drive member which drives at least one film of the pair of the interferometric films to change a distance of a gap between the interferometric films.

2. The color filter according to claim 1, wherein
the color filter is employed for an image sensor in which a plurality of pixels are arrayed; and
the pair of the interferometric films is disposed to be shared by all the plurality of pixels.

3. The color filter according to claim 1, wherein
the color filter is employed for an image sensor in which a plurality of pixels are arrayed;
the pair of the interferometric films is individually disposed to correspond to each of the plurality of pixels; and
the drive member individually changes the distance of the gap between the pair of the interferometric films corresponding to each pixel.

4. A color image sensor, comprising:
a color filter including at least one pair of interferometric films which are substantially parallel to each other and which transmit light;
a plurality of photoelectric converters which are arrayed two-dimensionally to receive the respective light transmitted through the color filter and to output electrical signals; and
a drive member which changes the wavelengths of the light transmitted through the corresponding pair of the interferometric films by moving at least one film of the pair of the interferometric films to change a distance of a gap between the interferometric films.

5. The color image sensor according to claim 4, wherein each photoelectric converter is configured to detect various light with different wavelengths at different timings by utilizing change in the wavelengths of the light transmitted through the color filter.

6. The color image sensor according to claim 4, further comprising:
an interlayer insulating film disposed between the color filter and the photoelectric converters; and
a plurality of microlenses disposed on or above the color filter at positions corresponding to the respective photoelectric converters.

7. The color image sensor according to claim 6, further comprising:
means for measuring the gap distance between the interferometric films, wherein
the color image sensor is configured to detect outputs of the photoelectric converters when the gap distance measured with the measuring means becomes a predetermined value.

8. The color image sensor according to claim 7, further comprising means for controlling the gap distance between the interferometric films within a predetermined range.

9. The color image sensor according to claim 6, further comprising:
a measuring member configured to measure the gap distance between the interferometric films, wherein
the color image sensor is configured to detect outputs of the photoelectric converters when the gap measured with the measuring member becomes a predetermined value.

10. The color image sensor according to claim 9, further comprising a controller configured to control the gap between the interferometric films within a predetermined range.

11. The color filter according to claim 1, wherein the drive member is provided on the interferometric films and between the interferometric films.

12. The color filter according to claim 11, wherein the drive member is provided on a corner of the interferometric films.

13. The color image sensor according to claim 4, wherein the drive member is provided on the interferometric films and between the interferometric films.

14. The color image sensor according to claim 13, wherein the drive member is provided on a corner of the interferometric films.

15. The color image sensor according to claim 4, further comprising a plurality of microlenses disposed on or above the color filter at positions corresponding to the respective photoelectric converters, and
wherein the drive member is provided on the interferometric films except under the microlenses.

16. The color image sensor according to claim 15, wherein the drive member is provided on a diagonal corners of the interferometric films.

17. The color image sensor according to claim 4, wherein the drive member is provided on the interferometric films.
